(19) United States
(12) Patent Application Publication
(10) Pub. No.: US 2026/0340123 A1
(43) Pub. Date: Oct. 29, 2026

(54) METHOD AND SYSTEM FOR OBTAINING SELECTIVE MEMORY DUMPS

(71) Applicant: Aqua Security Software, Ltd., Ramat Gan (IL)

(72) Inventors: Ofek Shaked, Tel-Aviv (IL); Ori Glassman, Giv'atayim (IL); Idan Revivo, Tel-Aviv (IL); Asaf Eitani, Tel-Aviv (IL)

(21) Appl. No.: 19/188,430

(22) Filed: Apr. 24, 2025

(51) Int. Cl. G06F 21/56

(52) U.S. Cl. CPC G06F 21/56; G06F 2221/034

(57) ABSTRACT

A method of obtaining a selective memory dump includes determining, based on occurrence of a security incident on a Linux computing device, an inclusion group describing portions of memory of the Linux computing device to be included in a selective memory dump for the security incident, and an exclusion group describing portions of the memory to be excluded from the selective memory dump. The method also includes obtaining the selective memory dump that includes the portions of memory of the inclusion group and excludes the portions of memory of the exclusion group, such that the selective memory dump does not include all of the memory of the Linux computing device. The method also includes preparing a memory dump file that includes the selective memory dump. A Linux computing device is also disclosed.

### BACKGROUND

This application relates to cyber security, and more particularly to obtaining selective memory dumps.

As part of a cyber security team's response to a security incident, various information is collected from the affected assets (e.g., servers, workstations, etc.), and that information is analyzed with the goal of understanding the details of the incident, whether it's an actual cyber attack or a false positive, and what actions need to be performed to remedy the attack and mitigate the damage.

The process of analyzing collected evidence is referred to in the security industry as “digital forensics,” and there are various types of data that can be analyzed to get a better understanding of the attack.

One type of forensics that is often conducted during an incident is host forensics. Host forensics involves collecting data from an affected server or workstation's file system. This data often includes system files, application files and can possibly include files created by a malware program that infected the system. In the process of host forensics, live information is often collected from the machine by running system commands and dedicated collection tools. This information includes what programs are currently running, what network connections are active, and more.

While host forensics can be very useful during an investigation, it also has some drawbacks that can affect the investigation of advanced attacks. Some attacks involve altering the behavior of the operating system in a way that cannot be detected using regular host forensics methods. Additionally, an advanced malware can hide its activity from the tools used to collect the forensic data, thus rendering the host forensics investigation irrelevant.

Another type of forensics that is often employed alongside host forensics to mitigate its shortcomings is memory forensics. This kind of forensics involves taking a snapshot (“dump”) of the system's memory (i.e., RAM) and analyzing it using specialized tools, like Volatility3. A memory dump contains information about all the activity on the system at the time the dump was taken. Additionally, much of the system's persistent data (i.e., files) is present in the memory dump. The “files” referred to in the preceding sentence refers to files that exist in hard drive storage, but were accessed at some point while the system was running (or being accessed at the time of the memory dump), and thus their contents are loaded into memory (i.e., RAM).

Memory forensics is considered more reliable than host forensics for investigating advanced attacks, because the data is considered much more reliable. It is almost impossible for a malware to effectively hide its activity from a memory snapshot, and “fooling” memory forensics tools into displaying wrong results is much harder than controlling the data collected using host forensics methods. Additionally, memory forensics allows detection of very advanced attacks that alter the operating system's behavior.

However, collecting and analyzing a memory dump introduces challenges that may be hard to overcome in certain situations.

Collecting a memory dump involves running a special tool to read the contents of RAM and write them to a file or to a network destination. Known tools collect the entire system RAM, which can be very large on modern systems, especially when dealing with servers hosted in the cloud. Depending on the method of collection, the memory dump will often be written to the local file system and then sent over the network back to the investigators. Because of the large RAM sizes on some modern servers and the little storage size they may have, sometimes this approach is impossible, and the memory dump needs to be sent directly over the network which may take a very long time depending on the RAM size and network bandwidth. Apart from the time taken and storage size required, transferring large amounts of data over the network can be costly. Some memory collection tools compress the data before storing or sending it, but this significantly increases the time needed to perform a memory dump.

Apart from the logistical challenges detailed above, large RAM sizes may negatively affect the quality of the result memory dump by introducing a problematic phenomenon called memory smearing. Memory smearing happens when there is a significant time difference between the memory dump of one area of RAM being dumped and another area, which results in modification of data by the running system during the memory acquisition process. Generally, the longer it takes to perform the memory dump, the worse memory smearing will become. Memory smearing introduces inaccuracies in the analysis of the memory dump, and if it is bad enough it may completely prevent memory analysis tools from working.

The memory smearing issue further complicates the logistical issues, because solutions that may be easier logistically (like sending the dump directly over the network or compressing it) increase the memory acquisition time and contribute to memory smearing.

The issues outlined above have a significant negative effect over the feasibility of performing memory forensics in real world investigations, and the issue gets worse with time as RAM sizes continue to increase. In many real-world scenarios, memory forensics is deemed unfeasible because of logistical issues, and the ability to investigate advanced attacks is greatly reduced.

### SUMMARY

A method of obtaining a selective memory dump according to an example embodiment of the present disclosure includes determining, based on occurrence of a security incident on a Linux computing device, an inclusion group describing portions of memory of the Linux computing device to be included in a selective memory dump for the security incident, and an exclusion group describing portions of the memory to be excluded from the selective memory dump. The method also includes obtaining the selective memory dump that includes the portions of memory of the inclusion group and excludes the portions of memory of the exclusion group, such that the selective memory dump does not include all of the memory of the Linux computing device. The method also includes preparing a memory dump file that includes the selective memory dump.

In a further embodiment of the foregoing embodiment, the memory of the Linux computing devices includes kernel memory allocated through a plurality of kernel memory allocations, and the method includes analyzing metadata associated with the plurality of kernel memory allocations and determining, based on the metadata, whether each of the plurality of kernel memory allocations should be part of the inclusion group or the exclusion group.

In a further embodiment of any of the foregoing embodiments, the determining, based on the metadata of the kernel memory allocations, whether each of the plurality of kernel memory allocations should be included in the inclusion group or the exclusion group includes, for a particular kernel memory allocation, determining what kernel function allocated the particular kernel memory allocation based on the metadata of the particular kernel memory allocation; determining an object type of the kernel function; and determining whether the particular kernel memory allocation should be part of the inclusion group or the exclusion group based on the object type.

In a further embodiment of any of the foregoing embodiments, the obtaining the selective memory dump includes obtaining data from the kernel memory using at least one of a virtual file configured to provide access to the kernel memory, a kernel module configured to directly access arbitrary portions of the kernel memory, and a helper function of an Extended Berkley Packet Filter program, where the helper function is configured to read the kernel memory.

In a further embodiment of any of the foregoing embodiments, the method includes determining that a particular software container of the Linux computing device was involved in the security incident; and, based on the determining that the particular software container was involved in the security incident, including one or more portions of the memory that are associated with the particular software container in the inclusion group; and including one or more portions of the memory that are not associated with the particular software container in the exclusion group.

In a further embodiment of any of the foregoing embodiments, the memory includes kernel memory and process memory that is separate from the kernel memory, and the determining includes including process memory portions of the memory for one or more processes that are involved in the security incident in the inclusion group and including process memory portions of the memory for one or more processes that are not involved in the security incident in the exclusion group.

In a further embodiment of any of the foregoing embodiments, the method includes utilizing a memory forensics program to perform a forensic analysis of the selective memory dump. The determining includes including memory for one or more kernel objects that the memory forensics program is configured to access in the inclusion group and including memory for one or more kernel objects that the memory forensics program is not configured to access in the exclusion group.

In a further embodiment of any of the foregoing embodiments, the memory includes kernel memory and process memory that is separate from the kernel memory and includes a plurality of process memory allocations of the process memory. The obtaining the selective memory dump includes obtaining data from a particular process memory allocation for a particular process by at least one of translating one or more virtual addresses of the particular process memory allocation to physical addresses via one or more page tables of the particular process, and accessing the one or more page tables via an identity mapped physical memory in an address space of a kernel of the Linux computing device; utilizing a virtual file that is configured to provide privileged program access to the process memory of the particular process memory allocation; and utilizing a helper function via an Extended Berkley Packet Filter program, where the helper function is configured to read the process memory of the particular process memory allocation.

In a further embodiment of any of the foregoing embodiments, the method includes, after occurrence of the security incident and prior to the obtaining and preparing, triggering a slab cache cleanup for the memory.

In a further embodiment of any of the foregoing embodiments, the selective memory dump file utilizes a Linux Memory Extractor (LiME) format.

In a further embodiment of any of the foregoing embodiments, the selective memory dump includes a plurality of contiguous ranges of physical memory. The preparing the memory dump file includes joining adjacent memory ranges into a single, larger memory range in the LiME format memory dump file.

In a further embodiment of any of the foregoing embodiments, the exclusion group includes data stored in cached file contents, non-allocated memory, and allocated memory that contains no data.

A Linux computing device according to an example embodiment of the present disclosure includes processing circuitry operatively connected to memory, configured to run Linux, and configured to determine, based on occurrence of a security incident of the Linux computing device, an inclusion group describing portions of memory of the Linux computing device to be included in a selective memory dump for the security incident, and an exclusion group describing portions of the memory to be excluded from the selective memory dump. The processing circuitry is configured to obtain the selective memory dump that includes the portions of memory of the inclusion group and excludes the portions of memory of the exclusion group, such that the selective memory dump does not include all of the memory of the Linux computing device, and is configured to prepare a memory dump file that includes the selective memory dump.

In a further embodiment of the foregoing embodiment, the memory of the Linux computing devices includes kernel memory allocated through a plurality of kernel memory allocations. The processing circuitry is configured to analyze metadata associated with the plurality of kernel memory allocations and determine, based on the metadata, whether each of the plurality of kernel memory allocations should be part of the inclusion group or the exclusion group.

In a further embodiment of any of the foregoing embodiments, to determine based on the metadata of the kernel memory allocations, whether each of the plurality of kernel memory allocations should be included in the inclusion group or the exclusion group, the processing circuitry is configured to, for a particular kernel memory allocation: determine what kernel function allocated the particular kernel memory allocation based on the metadata of the particular kernel memory allocation; determine an object type of the kernel function; and determine whether the particular kernel memory allocation should be part of the inclusion group or the exclusion group based on the object type.

In a further embodiment of any of the foregoing embodiments, to obtain the selective memory dump, the processing circuitry is configured to obtain data from kernel memory using at least one of a virtual file configured to provide access to the kernel memory, a kernel module configured to directly access arbitrary portions of the kernel memory, and a helper function of an Extended Berkley Packet Filter program, where the helper function is configured to read the kernel memory.

In a further embodiment of any of the foregoing embodiments, the processing circuitry is configured to determine that a particular software container of the Linux computing device was involved in the security incident and, based on the determination that the particular software container was involved in the security incident, include one or more portions of the memory that are associated with the particular software container in the inclusion group and include one or more portions of the memory that are not associated with the particular software container in the exclusion group.

In a further embodiment of any of the foregoing embodiments, the memory includes kernel memory and process memory that is separate from the kernel memory. To determine the inclusion group and the exclusion group, the processing circuitry is configured to include process memory portions of the memory for one or more processes that are involved in the security incident in the inclusion group and include process memory portions of the memory for one or more processes that are not involved in the security incident in the exclusion group.

In a further embodiment of any of the foregoing embodiments, a memory forensics program is configured to perform a forensic analysis of the selective memory dump. To determine the inclusion group and the exclusion group, the processing circuitry is configured to include memory for one or more kernel objects that the memory forensics program is configured to access in the inclusion group and include memory for one or more kernel objects that the memory forensics program is not configured to access in the exclusion group.

In a further embodiment of any of the foregoing embodiments, the memory includes kernel memory and process memory that is separate from the kernel memory and includes a plurality of process memory allocations of the process memory. To obtain the selective memory dump, the processing circuitry is configured to obtain data from a particular process memory allocation for a particular process by at least one of: translation one or more virtual addresses of the particular process memory allocation process to physical addresses via one or more page tables of the particular process, and access to the one or more page tables via an identity mapped physical memory in an address space of a kernel of the Linux computing device; utilization of a virtual file that is configured to provide privileged program access to the process memory of the particular process memory allocation; and utilization of a helper function via an Extended Berkley Packet Filter program, where the helper function is configured to read the process memory of the particular process memory allocation.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1A schematically illustrates an example system for obtaining selective memory dumps.

FIG. 1B schematically illustrates some example software elements of a computing device of FIG. 1.

FIG. 2 is a flowchart of an example method of obtaining selective memory dumps.

FIG. 3 schematically illustrates example memory contents for a Linux computing device.

FIG. 4 is a flowchart that contrasts example utilization of traditional, full memory dumps and an example utilization of a selective memory dump.

### DETAILED DESCRIPTION

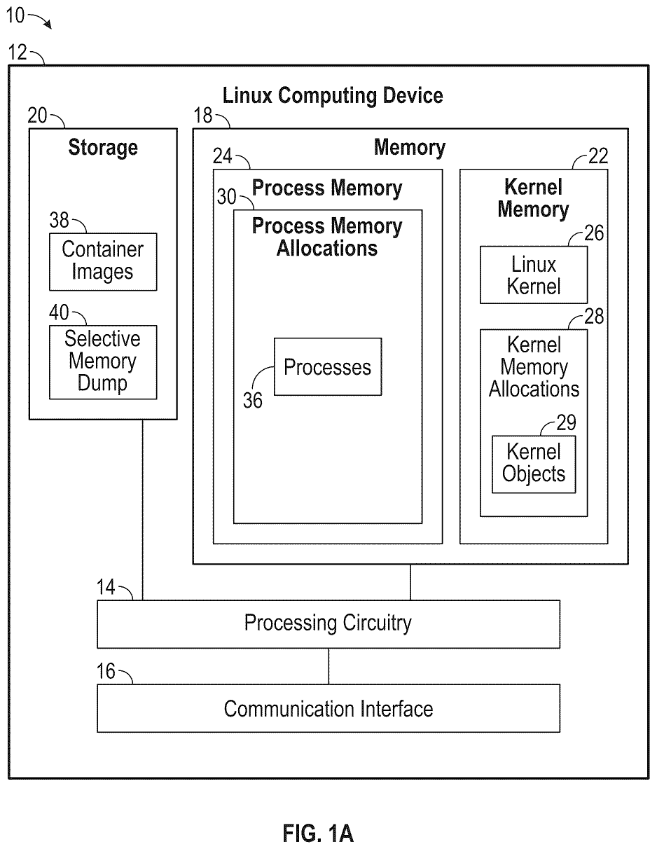

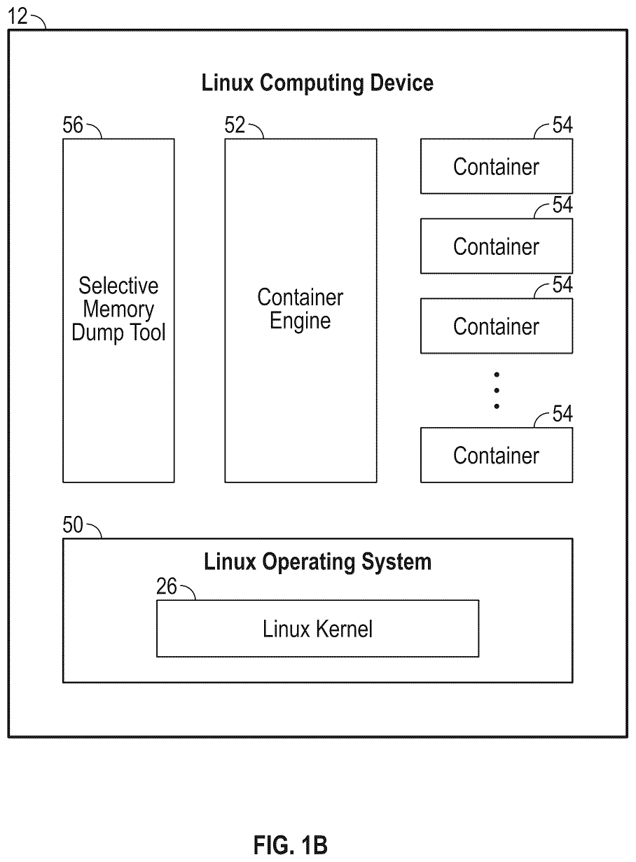

FIG. 1A schematically illustrates an example system 10 for obtaining selective memory dumps that can provide a solution to the various challenges described above. The system 10 includes a Linux computing device 12 (which may be a server, for example) that runs on the Linux operating system, and includes processing circuitry 14 operatively connected to a communication interface 16, memory 18 (i.e., random-access memory, also known as “RAM”), and storage 20. As used herein, the term “memory” only refers to RAM, and not to other types of memory (e.g., read-only memory or hard drive storage). The processing circuitry 14 includes one or more microprocessors, microcontrollers, application specific integrated circuits (ASICs), or the like. The communication interface 16 is configured to facilitate communication between the Linux computing device 12 and other computing devices, and may include a wireless and/or wired transceiver, for example.

The memory 18 includes kernel memory 22 and process memory 24 (also known as “user space memory”), which is separate from the kernel memory 22. That is, while a single memory chip may be used for both kernel memory 22 and process memory 24, the kernel memory 22 and process memory 24 are handled and allocated separately from each other. The kernel memory 22 includes a Linux kernel 26 that supports operation of the Linux operating system running on the Linux computing device 12, and also includes a plurality of kernel memory allocations 28 corresponding to portions of the kernel memory 22 that are allocated to kernel objects 29. The process memory 24 includes a plurality of process memory allocations 30.

The storage 20 includes non-volatile memory (e.g., a hard drive) that includes a plurality of container images 38 that a container engine 52 (e.g., Docker) is configured to instantiate as a plurality of software containers 54 (see FIG. 1B). Software containers are lightweight, portable, and self-contained packages that encapsulate an application and its dependencies, allowing it to run consistently across different environments. Unlike a virtual machine, which requires an operating system to run within the virtual machine, a container does not include an operating system, and in fact multiple containers can run on a single host device.

The storage 20 also includes a selective memory dump 40 that will be discussed below in greater detail. As mentioned above, existing memory acquisition tools simply write out the entire contents of RAM to a single file, whose size before compression is the size of the system's RAM. Although this approach is simple and generally ensures that there is no data missing in the memory dump (assuming significant memory smearing does not occur), in practice this approach is very wasteful, because most of the contents of RAM are useless for memory forensics.

The present disclosure instead utilizes a selective memory dump tool 56 (see FIG. 1B) to obtain a selective memory dump 40 that only includes a portion of the memory 18, and in many instances may be significantly smaller than a traditional, full memory dump (e.g., 95% or more smaller). In one or more embodiments, the selective memory dump 40 only includes data that is relevant to memory forensics for a particular security incident, and excludes memory not relevant to the memory forensics for the security incident. The use of a selective memory dump has been found by the inventors to, in certain scenarios, reduce the memory dump size by 99% while retaining nearly all functionality needed during memory forensics. In one or more embodiments, the exclusion of memory from the selective memory dump 40 occurs implicitly by the selective memory dump tool 56 only choosing items of interest for inclusion in the selective memory dump 40, and not choosing items for inclusion in the selective memory dump 40 that are irrelevant and/or not of interest.

Referring now to FIG. 1B, some example software elements of the Linux computing device 12 of FIG. 1 are schematically shown. As shown, the Linux kernel 26 is part of the Linux operating system 50 that runs on the Linux computing device 12. A selective memory dump tool 56 is configured to obtain the selective memory dump 40 shown in FIG. 1A, using any one or combination of the techniques discussed herein. The container engine 52 is configured to instantiate one or more of the container images 38 into software containers 54.

Typically, memory forensics tools provide analyses that can be run on the memory dump by an investigator. In Volatility3, the most well-known memory forensics tool, these analyses are called “plugins.” Plugins can be divided into 3 groups according to what kind of memory they need to access to perform their task and how they do it (a plugin may belong to more than one group):
plugins that access operating system objects directly in the Linux kernel 26 and in the kernel memory allocations 28 (most plugins belong only to this group);
plugins that scan dumped memory for operating system objects (e.g., scan memory and look for process objects—so indirectly accessing the objects); and
plugins that access process memory 24.

By understanding what kind of memory each plugin accesses, the selective memory dump tool 56 can be configured to tailor the selective memory dump 40 to a specific set of analysis use cases. If a determination is made of which kinds of kernel objects 29 and which processes are needed for analysis, then those objects and processes can be selectively dumped. This is also useful for the second type of plugin listed above (those that scan kernel memory for certain types of objects), because if all instances of the types of objects that these plugin search for is selectively dumped, these plugins will be able to find them in the dump.

In general, there are two types of memory allocation performed by the Linux kernel 26: kernel memory allocations 28 of kernel memory 22, and process memory allocations 30 of process memory 24.

Kernel memory 22 can be allocated from many places in the kernel's code, including from loadable kernel modules. Kernel memory allocations 28 can hold various objects used and managed by the kernel 26. In general, kernel memory 22 is only accessible in “kernel-mode” (also referred to as “ring-0”), essentially meaning that only code that belongs to the kernel 26 or a kernel module can access kernel memory 22.

Objects allocated by the kernel 26 to kernel memory 22 are used to manage various aspects of the running system, and many of them are inspected by memory forensics plugins. Kernel memory allocations 28 are predictable, in the sense that for the most part, a certain piece of kernel code will always allocate memory for the same kind of object in the same way. Also, most of these memory allocations contain metadata that identifies what they contain, which could be leveraged by a memory acquisition tool to identify if a piece of allocated memory is needed for memory analysis.

An example of metadata that identifies the contents of a kernel memory allocation 28 can be found in slab allocations. In Linux, a slab allocator manages pools of objects called “slab caches.” Each pool contains objects of a certain type, e.g. process objects (which are a type of kernel object). Given a piece of memory that was allocated by the slab allocator, one can inspect its metadata to find the slab cache that its allocation belongs to, which identifies what kind of object it is.

Another example can be found in vmalloc allocations, which are intended for larger objects. These allocations contain metadata about the code location that allocated them. By identifying which kernel function this code location belongs to, one can understand what kind of object the vmalloc allocation contains.

The Linux kernel 26 also manages process memory 24 which is allocated for user processes 36. This includes all applications and services that a standard user runs, as well as operating system services that operate in user space. Any memory utilized by these processes is considered user space memory. A dedicated component of the kernel 26 manages user space memory allocation. When memory is assigned to a process 36, it becomes part of that process's virtual address space, ensuring exclusive access. However, there are a few exceptions that allow external access to a process's memory, which will be discussed later.

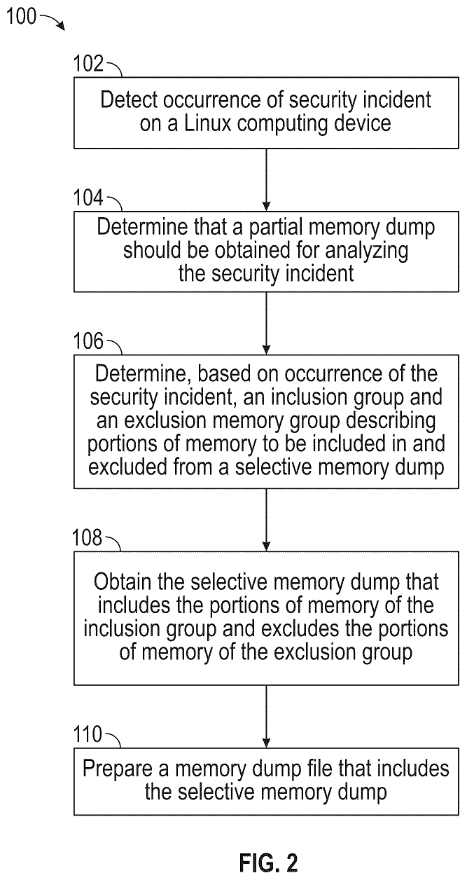

FIG. 2 is a flowchart of an example method 100 of obtaining selective memory dumps. Occurrence of a security incident on the Linux computing device 12 is detected (step 102), and a determination is made that a selective memory dump 40 should be obtained for analyzing the security incident (step 104). Based on the occurrence of the security incident on the Linux computing device 12, a determination is made of an inclusion group describing portions of memory 18 of the Linux computing device 12 to be included in the selective memory dump 40 for the security incident, and an exclusion group describing portions of the memory 18 to be excluded from the selective memory dump 40 (step 106).

The selective memory dump 40 is obtained that includes the portions of memory of the inclusion group and excludes the portions of memory of the exclusion group based on the determining step 106 (step 108), and a memory dump file is prepared that includes the selective memory dump 40 (step 110). In one or more embodiments, the memory dump file utilize a format that a memory forensics tools can use (e.g., the Linux Memory Extractor “LiME” format). The selective memory dump 40 may then be provided to the forensic memory tool for analysis, and the forensic memory tool may be utilized for analyzing the selective memory dump 40. In one or more embodiments, at least steps 106, 108, and 110 are performed by a computing device (e.g., Linux computing device 12). In one or more embodiments, steps 102 and/or 104 are also performed by the same or another computing device.

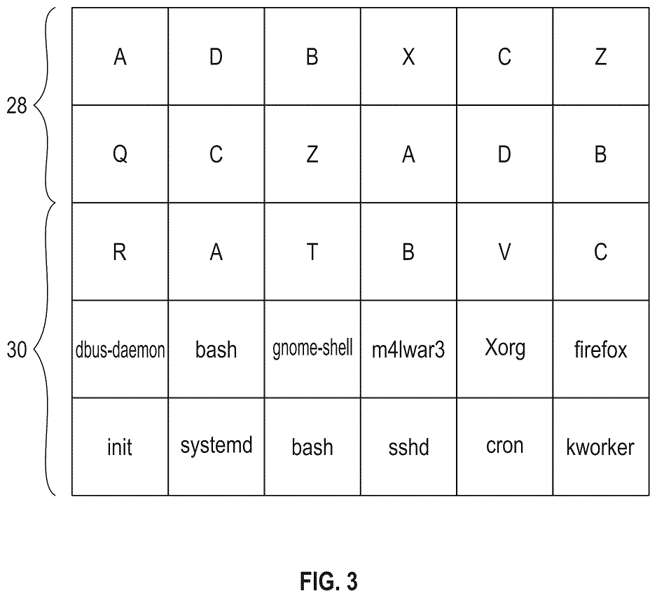

Step 106 will now be discussed in more detail. As discussed above, there are two types of memory areas that we can dump: kernel memory 22 (which has kernel memory allocations 28) and process memory 24 (which has process memory allocations 30). Kernel memory allocations 28 can be dumped in a granularity level of which types of kernel objects 29 are need for the analysis (e.g. A, B and C in FIG. 3), and process memory 24 can be dumped in a granularity level of which processes 36 are desired for analysis (e.g. “bash” and “m4lwar3” in FIG. 3).

In one or more embodiments, the decision about what portions of memory are part of the inclusion group and which portions are part of the exclusion group is tailored to the specific forensic memory plugin that will be used, and which kernel objects 29 and processes the plugin is configured to and/or needs to access.

For example, the “pslist” Volatility plugin accesses process objects and the “sockstat” plugin accesses both process and socket objects. The results can then be divided into different types of artifacts (e.g. network artifacts, filesystem artifacts) which can be selected when performing the memory dump and will affect which plugins can be used to investigate the dump. Further, these artifact selections can be combined into presets that are tailored for different kinds of investigations.

Thus, in one or more embodiments, the determining of step 106 includes memory for one or more kernel objects 29 that the memory forensics program is configured to access in the inclusion group, and includes memory for one or more kernel objects 29 that the memory forensics program is not configured to access in the exclusion group. In one or more embodiments, the determination of which kernel memory allocations 28 should be part of the inclusion group and/or which should be part of the exclusion group is based on an analysis of metadata of the kernel allocations.

In one or more embodiments, the decision about what portions of memory are part of the inclusion group and which portions are part of the exclusion group is based less (or not at all) on plugin requirements, but rather is based on the security incident that is being investigated (e.g., if you know a process is suspicious, then make its corresponding memory allocation part of the inclusion group). While some memory analysis plugins require specific processes to be dumped, most plugins that access process memory will operate on any process whose memory is present in the dump. Thus, one can selectively dump only processes that are involved in the security incident that triggered the memory acquisition. Thus, in one or more embodiments, step 106 includes including process memory 24 portions that are involved in the security incident in the inclusion group, and including process memory 24 portions for one or more processes that are not involved in the security incident in the exclusion group.

In one or more embodiments, a process 36 is determined to be “involved in” a security incident if there are any indications (e.g., provided by some sort of security monitoring solution) that the incident happened within the context of the “involved” process 36. In one or more further embodiments, a process 36 is determined to be “involved in” the security incident if by nature of the security incident, the process 36 has any concrete connection to the security incident (e.g. a process injected code into another process 36, then both processes 36 are “involved”).

Step 106 may also be performed based on the container 34 that a security incident is involved in (e.g., occurs in). In one or more embodiments, step 106 includes determining that a particular software container 34 of the Linux computing device 12 was involved in the security incident; and based on that determination: including one or more portions of the memory 18 that are associated with the particular software container 34 in the inclusion group, and including one or more portions of the memory 18 that are not associated with the particular software container 34 in the exclusion group. Thus, a process 36 may be determined to be “associated with” a container 54 by simply belonging to it-at its simplest form, a container 54 is a group of processes, and all of these processes are “associated with” the container 54.

In one or more embodiments, if the Linux computing device 12 is a server running a software container 34 (as in the example of FIG. 1), the inclusion group includes all processes in the specific container 34 that were involved in the security incident (“dump the container”), and the exclusion group includes all, or a majority, of the memory that is not part of the software container 34.

As discussed above, the processing circuitry 14 may analyze metadata of kernel memory allocations 28 to determine whether associated kernel memory 22 should be part of the inclusion group or the exclusion group. In one or more embodiments, this includes the following for a plurality of particular kernel memory allocations: determining what kernel function is allocated the particular kernel memory allocation based on the metadata of the kernel memory allocation 28; determining an object type of the kernel function (e.g., process object, file object, or network socket object); and determining whether the kernel memory allocation 28 should be part of the inclusion group or the exclusion group based on the object type.

In one or more embodiments, the exclusion group includes one or any combination of the following: data stored in cached file contents, non-allocated memory, and allocated memory that contains no data.

Some additional examples for performance of step 106 will now be provided for different security incidents. In one or more embodiments, the security incident corresponds to discovery of a malicious file on the Linux computing device 12, and step 106 is performed so that the inclusion group includes one or any combination of the following: filesystem artifacts (e.g., a collection of kernel objects that contain information related to the artifact) to determine if there are any related files, network artifacts to determine how the file got to the computer, and if the file was executed, if the file is performing any network activity, and process artifacts to determine if the file was executed, and if so, what other activity the malicious process is doing. If the malicious file was executed and we know which process 36 or container executed it, it is desirable to dump the memory of this process 36 or container 54.

In one or more embodiments, the security incident corresponds to discovery of a rootkit at runtime, and step 106 is performed so that the inclusion group includes any one or combination of the following: kernel modules and Extended Berkley Packet Filter (eBPF) programs (to be able to get details on the rootkit and potentially extract its code and data), filesystem artifacts (to determine if there are any related files), network artifacts (to determine how the rootkit got to the computer and if the rootkit is performing any network activity), and process artifacts (to try and determine if there are any processes that are communicating with the rootkit).

In one or more embodiments, the security incident corresponds to detection of a suspicious network operation (e.g., a reverse shell was spawned), and step 106 is performed so that the inclusion group includes any one or combination of the following: network artifacts (to extract more information about this suspicious network operation and see if there are any related network communications), process artifacts (to extract information about the process that performed the network operation, and determine if the process performed any other suspicious activity), and filesystem artifacts (to determine if there are any files being used by the suspicious process that are related). It would also be beneficial here for the selective memory dump 40 to include the memory of the process 36 or container 54 that performed the suspicious network operation.

In one or more embodiments, after occurrence of the security incident but prior to performance of step 108 where the selective memory dump is obtained, the processing circuitry 14 performs one or more steps to reduce the size of the memory dump. In one particular example, the processing circuitry 14 triggers a slab cache cleanup procedure by writing to/proc/sys/vm/drop_caches. This causes the Linux kernel 26 to free any unused objects, which could in some scenarios significantly reduce the size of the selective memory dump 40.

Step 108 will now be discussed in more detail. As mentioned above, for kernel memory 22, kernel objects 29 can be identified by the metadata of their memory allocation, while process memory can be dumped via the virtual address space of each process that we want to dump. While the standard way of accessing kernel memory is from kernel-mode (using kernel code) and accessing process memory is supposed to be performed from within the process, there are a few exceptions that allow a memory acquisition tool to access these areas of memory.

In one or more embodiments, step 110 is performed using one or more of the following: a virtual file configured to provide access to the kernel memory (e.g., the /proc/kcore, /dev/mem or/dev/kmem virtual files); a kernel module configured to directly access arbitrary portions of the kernel memory 22; and a helper function of an eBPF program, wherein the helper function is configured to read the kernel memory 22. Each of these techniques are utilized by one or more known memory acquisition tools, but they are only known for obtaining full memory dumps, and it is not known to use these techniques for selective memory dumps.

There are a number of different ways that step 108 can be performed to dump process memory 24.

One example technique for accessing process memory 24 is translating one or more virtual addresses of a process memory allocation 30 for a particular process 36 to physical addresses via one or more page tables of the process 36, and accessing the one or more page tables via an identity mapped physical memory in an address space of a kernel of the Linux computing device 12. This technique requires access to kernel memory 22.

Another example technique for accessing process memory 24 is utilizing a virtual file (e.g., /proc/<pid>/mem) that provides privileged program access to the process memory 24 of a particular process memory allocation 30. In fact, /proc/<pid>/mem provides privileged program access to the memory of any process. No existing memory forensics tools perform any kind of process memory dumping—instead they rely on the fact that all process memory is included in the dumped physical memory.

Another example technique for accessing process memory 24 is utilizing a helper function (e.g., bpf_copy_from_user_task) via an eBPF program, wherein the helper function is configured to read the process memory of the particular process memory allocation. The bpf_copy_from_user_task helper function can read arbitrary process memory from any process 36.

These last two techniques are different from the first technique mentioned above (translating virtual addresses) because they cause a page fault if the memory is not present. This means that if part of a process'virtual memory is not backed by any physical memory (e.g. swapped to disk or mapped lazily by the kernel), it will be loaded into memory to satisfy the memory access request, unlike the first example which can only access process memory that is backed by real physical memory. This difference can be used strategically by a memory acquisition tool to prevent massive process memory allocations from being dumped if they are mapped lazily (and thus contain no data), while still being able to access important memory locations that may have been swapped to disk.

Step 110 will now be discussed in more detail. The most common file format used for Linux memory forensics is the LiME format, a format which was created for the LiME (Linux Memory Extractor) memory acquisition tool, but has since been used by other tools. The LiME format organizes memory into contiguous ranges of physical memory and prepends each range with metadata about that memory range.

To construct a LiME dump file, one needs to process all the small chunks of memory that were collected in step 108 and organize them into a set of physical memory ranges. For performance considerations, it would be beneficial to minimize the number of memory ranges in the file by joining adjacent memory ranges into a single, larger memory range. If memory in the inclusion group is virtual memory having a virtual address(es), to be dumped the virtual address(es) must be translated to physical address(es) for the selective memory dump file. An example of how this could be achieved is by performing page table walks to translate the virtual address of each memory range to the corresponding physical address.

FIG. 3 schematically illustrates example memory contents for a Linux computing device, and in particular illustrates a plurality of kernel memory allocations 28 (e.g., A, B, C, D, etc.), and a plurality of process memory allocations 30 (e.g., for processes d-bus-daemon, bash, gnome-shell, etc.). In one example, the “A” blocks represent kernel objects 29 that are process objects, the “B” blocks represent kernel objects 29 that are file objects, and the “C” blocks represent kernel objects 29 which are network socket objects. In one particular example, only the A, B, and C kernel objects 29 from the kernel memory allocations 28 and the “bash” and “m4lwar3” processes 36 are part of the inclusion group, and the remaining items are part of the exclusion group.

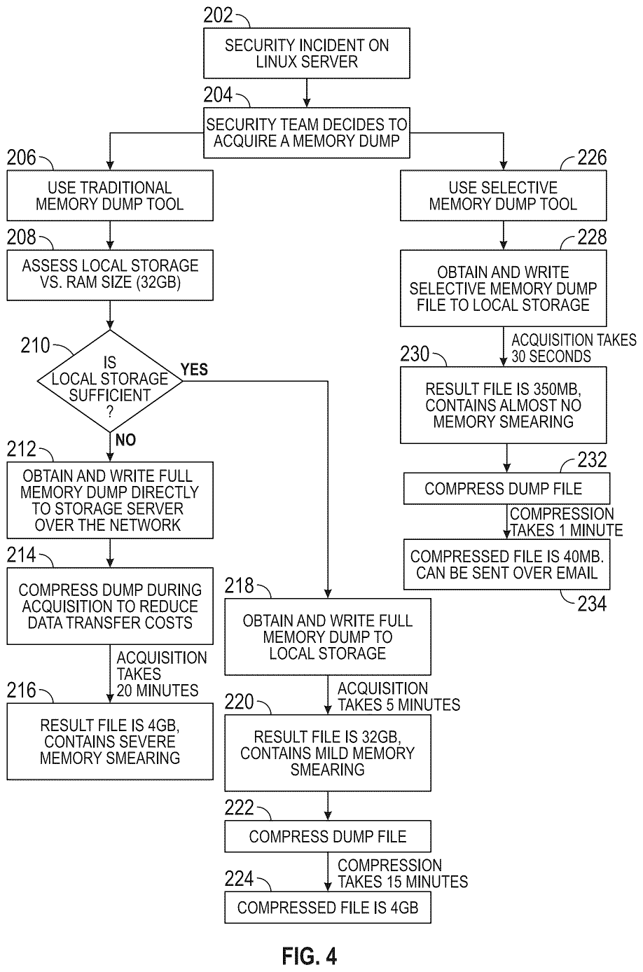

FIG. 4 is a flowchart contrasting utilization of traditional, full memory dumps (see steps 206-224) and utilization of a selective memory dump (see steps 226-234). A security incident occurs on a Linux server (step 202), and a security team decides to acquire a memory dump based on the incident (step 204). A traditional memory dump acquisition tool is utilized (step 206), and it determines that there is 32 GB of memory, and the memory dump acquisition tool assesses whether 32 GB of memory is available in local storage (step 208, 210). If the local storage does not include sufficient available storage (a “no” to step 210), the memory dump is obtained and written directly to a storage server over a network (step 212), and the dump is compressed during acquisition to reduce data transfer costs (step 216). Steps 212-214 take approximately 20 minutes, and this results in producing a resulting full memory dump file that is 4 GB in size, and contains severe memory smearing (step 216).

If sufficient storage is available locally (a “yes” to step 210), the memory dump is obtained and written to local storage, which takes approximately 5 minutes, and this results in producing a 32 GB memory dump file that contains mild memory smearing (step 220). The dump file is compressed (step 222), which takes about 15 minutes, and the compressed dump file is produced that is 4 GB in size (step 224).

Now, an example application of the method 100 will be discussed. A selective memory dump tool is utilized, which is configured to perform at least steps 106-110 of the method 100 (step 226). The selective memory dump tool may be a process 36 that runs in the memory 18 of FIG. 1, for example. The selective memory dump tool obtains and writes a selective memory dump 40 to local storage (step 228). This acquisition takes about 30 seconds, and results in a 350 MB selective memory dump file, which contains almost no memory smearing (step 230). The selective memory dump file is compressed (step 232), which takes about 1 minute, and results in a 40 MB compressed selective memory dump file that is small enough to be sent over email (step 234). This goes to show some of the improvements provided by the method 100 in various circumstances.

Although the selective memory dump features and techniques of the present disclosure have been discussed in the context of software containers, it is understood that selective memory dumps may also be created for Linux computing devices that do not utilize software containers.

Also, although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method of obtaining a selective memory dump, comprising:
determining, based on occurrence of a security incident on a Linux computing device, an inclusion group describing portions of memory of the Linux computing device to be included in a selective memory dump for the security incident, and an exclusion group describing portions of the memory to be excluded from the selective memory dump;
obtaining the selective memory dump that includes the portions of memory of the inclusion group and excludes the portions of memory of the exclusion group, such that the selective memory dump does not include all of the memory of the Linux computing device; and
preparing a memory dump file that includes the selective memory dump.

2. The method of claim 1, wherein the memory of the Linux computing devices includes kernel memory allocated through a plurality of kernel memory allocations, and the method comprises:
analyzing metadata associated with the plurality of kernel memory allocations; and
determining based on the metadata, whether each of the plurality of kernel memory allocations should be part of the inclusion group or the exclusion group.

3. The method of claim 2, wherein said determining based on the metadata of the kernel memory allocations, whether each of the plurality of kernel memory allocations should be included in the inclusion group or the exclusion group comprises, for a particular kernel memory allocation:
determining what kernel function allocated the particular kernel memory allocation based on the metadata of the particular kernel memory allocation;
determining an object type of the kernel function; and
determining whether the particular kernel memory allocation should be part of the inclusion group or the exclusion group based on the object type.

4. The method of claim 2, wherein said obtaining the selective memory dump comprises obtaining data from the kernel memory using at least one of:
a virtual file configured to provide access to the kernel memory;
a kernel module configured to directly access arbitrary portions of the kernel memory;
a helper function of an Extended Berkley Packet Filter program, wherein the helper function is configured to read the kernel memory.

5. The method of claim 1, comprising:
determining that a particular software container of the Linux computing device was involved in the security incident; and
based on the determining that the particular software container was involved in the security incident:
including one or more portions of the memory that are associated with the particular software container in the inclusion group; and
including one or more portions of the memory that are not associated with the particular software container in the exclusion group.

6. The method of claim 1, wherein the memory includes kernel memory and process memory that is separate from the kernel memory, and said determining comprises:
including process memory portions of the memory for one or more processes that are involved in the security incident in the inclusion group; and
including process memory portions of the memory for one or more processes that are not involved in the security incident in the exclusion group.

7. The method of claim 1, comprising:
utilizing a memory forensics program to perform a forensic analysis of the selective memory dump;
wherein said determining comprises:
including memory for one or more kernel objects that the memory forensics program is configured to access in the inclusion group; and
including memory for one or more kernel objects that the memory forensics program is not configured to access in the exclusion group.

8. The method of claim 1, wherein the memory includes kernel memory and process memory that is separate from the kernel memory and includes a plurality of process memory allocations of the process memory, and said obtaining the selective memory dump comprises obtaining data from a particular process memory allocation for a particular process by at least one of:
translating one or more virtual addresses of the particular process memory allocation to physical addresses via one or more page tables of the particular process, and accessing the one or more page tables via an identity mapped physical memory in an address space of a kernel of the Linux computing device;
utilizing a virtual file that is configured to provide privileged program access to the process memory of the particular process memory allocation;
utilizing a helper function via an Extended Berkley Packet Filter program, wherein the helper function is configured to read the process memory of the particular process memory allocation.

9. The method of claim 1, comprising:
after occurrence of the security incident and prior to said obtaining and preparing, triggering a slab cache cleanup for the memory.

10. The method of claim 1, wherein the selective memory dump file utilizes a Linux Memory Extractor (LiME) format.

11. The method of claim 10, wherein:
the selective memory dump includes a plurality of contiguous ranges of physical memory; and
said preparing the memory dump file comprises joining adjacent memory ranges into a single, larger memory range in the LiME format memory dump file.

12. The method of claim 1, wherein the exclusion group includes:
data stored in cached file contents; and
non-allocated memory; and
allocated memory that contains no data.

13. A Linux computing device, comprising:
processing circuitry operatively connected to memory, configured to run Linux, and configured to:
determine, based on occurrence of a security incident of the Linux computing device, an inclusion group describing portions of memory of the Linux computing device to be included in a selective memory dump for the security incident, and an exclusion group describing portions of the memory to be excluded from the selective memory dump;
obtain the selective memory dump that includes the portions of memory of the inclusion group and excludes the portions of memory of the exclusion group, such that the selective memory dump does not include all of the memory of the Linux computing device; and
prepare a memory dump file that includes the selective memory dump.

14. The Linux computing device of claim 13, wherein the memory of the Linux computing devices includes kernel memory allocated through a plurality of kernel memory allocations, and the processing circuitry is configured to:
analyze metadata associated with the plurality of kernel memory allocations; and
determine based on the metadata, whether each of the plurality of kernel memory allocations should be part of the inclusion group or the exclusion group.

15. The Linux computing device of claim 14, wherein to determine based on the metadata of the kernel memory allocations, whether each of the plurality of kernel memory allocations should be included in the inclusion group or the exclusion group, the processing circuitry is configured to, for a particular kernel memory allocation:
determine what kernel function allocated the particular kernel memory allocation based on the metadata of the particular kernel memory allocation;
determine an object type of the kernel function; and
determine whether the particular kernel memory allocation should be part of the inclusion group or the exclusion group based on the object type.

16. The Linux computing device of claim 14, wherein to obtain the selective memory dump, the processing circuitry is configured to obtain data from kernel memory using at least one of:
a virtual file configured to provide access to the kernel memory;
a kernel module configured to directly access arbitrary portions of the kernel memory;
a helper function of an Extended Berkley Packet Filter program, wherein the helper function is configured to read the kernel memory.

17. The Linux computing device of claim 13, wherein the processing circuitry is configured to:
determine that a particular software container of the Linux computing device was involved in the security incident; and
based on the determination that the particular software container was involved in the security incident:
include one or more portions of the memory that are associated with the particular software container in the inclusion group; and
include one or more portions of the memory that are not associated with the particular software container in the exclusion group.

18. The Linux computing device of claim 13, wherein the memory includes kernel memory and process memory that is separate from the kernel memory, and to determine the inclusion group and the exclusion group, the processing circuitry is configured to:
include process memory portions of the memory for one or more processes that are involved in the security incident in the inclusion group; and
include process memory portions of the memory for one or more processes that are not involved in the security incident in the exclusion group.

19. The Linux computing device of claim 13, wherein:
a memory forensics program is configured to perform a forensic analysis of the selective memory dump; and
to determine the inclusion group and the exclusion group, the processing circuitry is configured to:
include memory for one or more kernel objects that the memory forensics program is configured to access in the inclusion group; and
include memory for one or more kernel objects that the memory forensics program is not configured to access in the exclusion group.

20. The Linux computing device of claim 13, wherein the memory includes kernel memory and process memory that is separate from the kernel memory and includes a plurality of process memory allocations of the process memory, and to obtain the selective memory dump, the processing circuitry is configured to obtain data from a particular process memory allocation for a particular process by at least one of:
translation one or more virtual addresses of the particular process memory allocation process to physical addresses via one or more page tables of the particular process, and access to the one or more page tables via an identity mapped physical memory in an address space of a kernel of the Linux computing device;
utilization of a virtual file that is configured to provide privileged program access to the process memory of the particular process memory allocation;
utilization of a helper function via an Extended Berkley Packet Filter program, wherein the helper function is configured to read the process memory of the particular process memory allocation.
